(19) United States
(12) Patent Application Publication
(10) Pub. No.: US 2013/0140774 A1
(43) Pub. Date: Jun. 6, 2013

(54) ANNULAR SEAL APPARATUS AND METHOD

(71) Applicants: Gocha Chochua, Sugar land, TX (US); William C. Maier, Almond, NY (US)

(72) Inventors: Gocha Chochua, Sugar land, TX (US); William C. Maier, Almond, NY (US)

(73) Assignee: DRESSER-RAND COMPANY, Olean, NY (US)

(21) Appl. No.: 13/521,179

(22) PCT Filed: Jan. 12, 2011
(86) PCT No.: PCT/US11/20945

§ 371 Date: Oct. 9, 2012

Related U.S. Application Data
(60) Provisional application No. 61/294,731, filed on Jan. 13, 2010.

(51) Int. Cl. F16J 15/453

(52) U.S. Cl. CPC F16J 15/453
USPC 277/303; 277/412

(57) ABSTRACT

A non-contacting shaft seal apparatus according to which an alternating array of axially-spaced, porous and non-porous annular segments extend radially-inward from the inside surface of an annular seal body and to a radial clearance defined between the segments and a rotating shaft.

This application claims priority to U.S. Patent Application Ser. No. 61/294,731, which was filed Jan. 13, 2010. The priority application is hereby incorporated by reference in its entirety into the present application.

### BACKGROUND

This disclosure relates in general to seal systems, and in particular to seal systems for use in rotor systems.

During the operation of a rotor system, a seal may sealingly engage a rotating shaft to maintain a pressure differential across the seal while reducing axial fluid leakage along the rotating shaft and across the seal. However, fluid leakage through the seal may generate deleterious destabilizing forces on the rotor system, especially if the seal is subjected to relatively large fluid pressures and/or a high shaft rotational speed; conditions which are often encountered in turbomachines. Conventional labyrinth seals are prone to this destabilization problem. In an effort to reduce destabilization, special damper seals may be used instead of a labyrinth seal. The damper seals may increase damping of shaft vibration, however, in most cases, the use of a damper seal is a compromise solution in that, although increased damping is provided by the damper seal, axial fluid leakage along the shaft is sometimes increased.

Therefore, what is needed is a seal apparatus or configuration that overcomes one or more of the problems described above.

### SUMMARY

Embodiments of the present disclosure may provide a seal apparatus. The seal apparatus can include a body having a longitudinal axis and defining a circumferentially-extending inside surface, and a plurality of axially-spaced annular segments extending radially inward from the inside surface of the body. The seal apparatus can also include a plurality of axially-spaced porous annular segments juxtaposed between adjacent axially-spaced annular segments.

Embodiments of the present disclosure may further provide a method of restricting axial leakage along a shaft having a longitudinal axis. The method may include rotating the shaft and sealingly engaging the shaft with a plurality of axially-spaced annular segments to reduce axial fluid leakage flow along the shaft. The method may also include damping the shaft vibration by disposing a porous annular segment between adjacent axially-spaced annular segments so that the porous annular segment abuts and extends between the adjacent axially-spaced annular segments.

Embodiments of the present disclosure may further provide a seal having an annular body having a longitudinal axis and defining an inside surface that extends circumferentially about the longitudinal axis. The seal may also include a plurality of axially-spaced, annular segments extending radially inward from the inside surface of the annular body and circumferentially about the longitudinal axis, each of the annular segments having a distal end, wherein adjacent axially-spaced annular segments define an annular channel therebetween. Moreover, the seal may also have a porous annular segment disposed in each annular channel and composed of a porous material, the porous material abutting and extending between the adjacent axially-spaced annular segments and being generally flush with the respective distal ends of the adjacent axially-spaced annular segments, the porous material having a porosity that ranges from about 0.7 to about 0.95.

### BRIEF DESCRIPTION OF THE DRAWINGS

The present disclosure is best understood from the following detailed description when read with the accompanying Figures. It is emphasized that, in accordance with the standard practice in the industry, various features are not drawn to scale. In fact, the dimensions of the various features may be arbitrarily increased or reduced for clarity of discussion

FIG. 1 is a sectional view of a rotor system according to an exemplary embodiment, the rotor system including a seal apparatus.

FIG. 2 is a graph showing a comparison of results of exemplary experimental analyses between different seal configurations.

FIG. 2A shows a section view of a prior art bushing seal, FIG. 2B shows a sectional view of a prior art labyrinth seal, and FIG. 2C shows a sectional view of an embodiment of the present invention, the performance characteristics of each seal configuration being compared in the graph shown in FIG. 2.

FIG. 3 is a sectional view of a portion of the rotor system of FIG. 1 according to an exemplary embodiment.

FIG. 4 is a flow chart illustration of a method of sealingly engaging a shaft, according to one or more embodiments of the disclosure.

### DETAILED DESCRIPTION

It is to be understood that the following disclosure describes several exemplary embodiments for implementing different features, structures, or functions of the invention. Exemplary embodiments of components, arrangements, and configurations are described below to simplify the present disclosure, however, these exemplary embodiments are provided merely as examples and are not intended to limit the scope of the invention. Additionally, the present disclosure may repeat reference numerals and/or letters in the various exemplary embodiments and across the Figures provided herein. This repetition is for the purpose of simplicity and clarity and does not in itself dictate a relationship between the various exemplary embodiments and/or configurations discussed in the various Figures. Moreover, the formation of a first feature over or on a second feature in the description that follows may include embodiments in which the first and second features are formed in direct contact, and may also include embodiments in which additional features may be formed interposing the first and second features, such that the first and second features may not be in direct contact. Finally, the exemplary embodiments presented below may be combined in any combination of ways, i.e., any element from one exemplary embodiment may be used in any other exemplary embodiment, without departing from the scope of the disclosure.

Additionally, certain terms are used throughout the following description and claims to refer to particular components. As one skilled in the art will appreciate, various entities may refer to the same component by different names, and as such, the naming convention for the elements described herein is not intended to limit the scope of the invention, unless otherwise specifically defined herein. Further, the naming convention used herein is not intended to distinguish between components that differ in name but not function. Further, in the following discussion and in the claims, the terms “including” and “comprising” are used in an open-ended fashion, and thus should be interpreted to mean “including, but not limited to.” All numerical values in this disclosure may be exact or approximate values unless otherwise specifically stated. Accordingly, various embodiments of the disclosure may deviate from the numbers, values, and ranges disclosed herein without departing from the intended scope. Furthermore, as it is used in the claims, the term “or” is intended to encompass both exclusive and inclusive cases, i.e., “A or B” is intended to be synonymous with “at least one of A and B,” unless otherwise expressly specified herein.

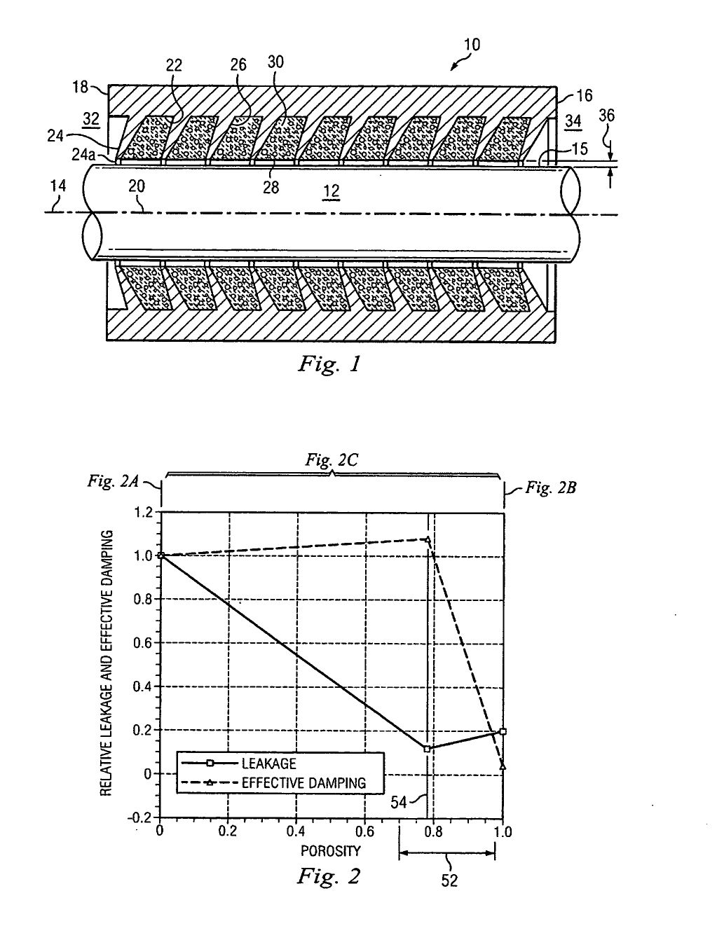

In an exemplary embodiment, as illustrated in FIG. 1, a rotor system is generally referred to by the reference numeral 10 and includes a shaft 12 having a longitudinal axis 14 and a smooth, constant radius surface 15. A seal apparatus 16 may be engaged with the shaft 12 and may include an annular body member 18 through which the shaft 12 extends. The annular body 18 has a longitudinal axis 20 substantially coaxial with the longitudinal axis 14 of the shaft 12 and defines an inside surface 22 radially-offset from and extending circumferentially about the longitudinal axis 20. The shaft 12 may be positioned within a casing (not shown), to which the annular body 18 is structurally coupled or otherwise seated. In several exemplary embodiments, the rotor system 10 form part of a turbomachine such as a turbine, expander, pump, or compressor.

The seal apparatus 16 may further include a plurality of axially-spaced, annular segments 24, each having a distal end 24a radially-aligned with adjacent distal ends 24a of corresponding adjacent segments 24. In one embodiment, each annular segment 24 may be substantially non-porous, or in other words a generally solid structure not having significant porosity. As illustrated, each annular segment 24 may extend radially-inward from the inside surface 22 of the annular body 18, and extend circumferentially about the longitudinal axis 20. As can be appreciated, adjacent segments 24 can define a channel 26 therebetween. In at least one embodiment, a porous segment 30 may be disposed or otherwise affixed within the channel 26 defined between each pair of adjacent, axially-spaced annular segments 24. Each porous segment 30 may be annular, but may also include two or more pieces or parts fit together between adjacent annular segments 24. In an exemplary configuration, each porous segment 30 may include a radially inner distal end 28 that can be generally flush with the respective distal ends 24a of the annular segments 24. In other embodiments, however, the radially inner distal ends 28 are not necessarily mounted flush with the respective distal ends 24a, but may also be unevenly mounted with respect thereto.

In an exemplary embodiment, the porous segments 30 can be composed of a porous material, for example, feltmetal, which is a metallic felt-like material. In other embodiments, instead of, or in addition to feltmetal, the porous segment 30 may be composed of one or more of the following: one or more other types of metallic felt-like materials, one or more types of non-metallic woven materials, one or more types of open cell foam material, a random array of cylindrical fibers that are bonded together and provide a relatively isotropic, e.g., uniform, fluid porosity, and/or any combination thereof. In at least one embodiment, the porous segments 30 may have a porosity, which is a measure of the void spaces in the porous segments 30 and which may be expressed as a fraction of the volume of voids over the total volume of the porous segments 30, between 0 to 1. In other exemplary embodiments, the porous segments 30 can have a porosity that ranges from about 0.7 to about 0.95.

In an exemplary embodiment, the porous segments 30 may be made integral with or suitably attached to the annular body 18 with mechanical fastening or a variety of welding processes. In one or more embodiments, the porous segments 30 may be coupled to the inside surface 22 of the annular body 18 by a tongue-and-groove fit. In several exemplary embodiments, instead of, or in addition to a tongue-and-groove fit, the porous segments 30 may be coupled to the inside surface 22 and/or one or both of the corresponding axial faces of the adjacent axially-spaced annular segments 24 by adhesive(s), welding, and/or brazing.

During operation of the rotor system 10, the shaft 12 may rotate relative to the seal apparatus 16 and about the longitudinal axis 14 and thus the longitudinal axis 20 coaxial therewith. The seal apparatus 16 may be axially positioned between a relatively high pressure region 32 and a relatively low pressure region 34. As a result, a pressure differential is generated across the seal apparatus 16. Both the annular segments 24 and the porous segments 30 of the seal apparatus 16 may be adapted to sealingly engage the shaft 12, thereby maintaining the pressure differential between the regions 32 and 34 and reducing axial fluid leakage flow from the high pressure region 32 to the low pressure region 34. To allow the shaft 12 to rotate during operation, a radial clearance 36 may be defined between the radially-aligned distal ends 24a of the segments 24 and the distal ends 28 of the porous segments 30 and the surface 15 of the shaft 12.

The primary mechanism of axial fluid leakage attenuation is through the dissipation of internal energy from the leakage fluid. The fluid is repeatedly accelerated into the radial clearance 36 between the distal ends 24a of the multiple annular segments 24 and the surface 15 of the shaft 12. Accelerating the fluid may transform a portion of its internal energy into kinetic energy. This relatively high velocity leakage fluid flow may then travel axially into a downstream porous segment 30. In an exemplary embodiment, within the porous segment 30 the kinetic energy may be at least partially dissipated by the combination of two mechanisms: first, the sudden expansion loss due to the increase in effective axial flow area in the porous segment 30; and second, drag losses realized in the interposed porous matrix of the porous segments 30.

During rotation of the shaft 12 and the resulting sealing engagement between the annular and porous segments 24,30 and the shaft 12, at least some degree of shaft 12 vibration damping may also be provided. The damping effect may result from the viscous dissipation of kinetic energy of the radial and axial fluid leakage and by minimizing circumferential perturbation propagation within the fluid leakage. In an exemplary embodiment, the porous segments 30 may be configured to simultaneously maximize damping of shaft 12 vibration while reducing axial fluid leakage flow along the shaft 12 from the high pressure region 32 to the low pressure region 34. In at least one exemplary embodiment, this may be accomplished by configuring the porosity of the porous segments 30 to be greater than or equal to about 0.7 but less than or equal to about 0.95.

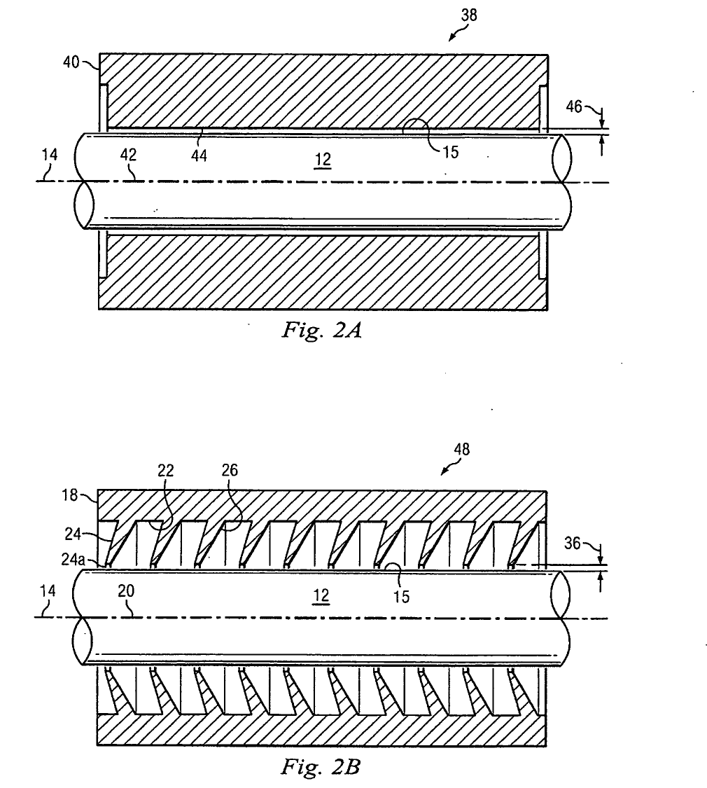

Referring now to FIGS. 2, 2A, 2B and 2C, with continuing reference to FIG. 1, exemplary experimental computational fluid dynamics (CFD) analyses were conducted with different experimental configurations of seals. FIG. 2 is a graph that summarizes the results of these exemplary experimental CFD analyses by plotting relative leakage and effective damping along the vertical axis, versus seal porosity along the horizontal axis for three (3) different configurations of seals, which are shown in FIGS. 2A, 2B and 2C, respectively.

The seal configuration shown in FIG. 2A is generally referred to by the reference numeral 38 and includes an annular body 40 through which the shaft 12 extends. The annular body 40 has a longitudinal axis 42, which is substantially coaxial with the longitudinal axis 14 of the shaft 12, and defines an inside surface 44 that extends circumferentially about the longitudinal axis 42. A radial clearance 46, which is substantially equal to the radial clearance 36 described above with reference to FIG. 1, is defined between the surface 44 of the annular body 40 and the surface 15 of the shaft 12. The seal configuration 38 would be a limiting embodiment of the seal apparatus 16 of FIG. 1 if the porosity of the porous segments 30 of the seal apparatus 16 was zero (0), that is, if the porous segments 30 were not porous. In at least one configuration, the seal configuration 38 may be characterized as a smooth seal or a smooth annular clearance bushing seal.

The seal configuration shown in FIG. 2B is generally referred to by the reference numeral 48. The seal configuration 48 would be another limiting embodiment of the seal apparatus 16 of FIG. 1 if the porosity of the porous segments 30 was set to 1, that is, if the porous material of the porous segments 30 was completely porous and effectively a void. In at least one configuration, the seal configuration 48 may be characterized as a traditional labyrinth seal. For ease of reference, the components of the seal configuration 48 of FIG. 2B are given the same reference numerals as the corresponding components of the seal apparatus 16 of FIG. 1, and therefore will not be described again in detail.

The seal configuration shown in FIG. 2C is generally referred to by the reference numeral 50 and is substantially similar to the seal apparatus 16 of FIG. 1. For ease of reference, the components of the seal configuration 50 of FIG. 2C are given the same reference numerals as the corresponding components of the seal apparatus 16 of FIG. 1, and therefore will not be described again in detail.

An exemplary experimental CFD analysis was conducted with the seal configuration 38 of FIG. 2A to normalize the experimental results presented in FIG. 2. That is, experimental axial fluid leakage flow along the shaft 12 and across the annular body 40 was determined by experimental CFD analysis and was normalized to one (1), as shown in FIG. 2. Experimental effective damping by the seal configuration 38 was also determined by the experimental CFD analysis and was normalized to one (1), as shown in FIG. 2. These normalizations to one (1) are plotted in FIG. 2 with porosity being equal to zero (0).

Another exemplary experimental CFD analysis was conducted with the seal configuration 48 of FIG. 2B. Experimental axial fluid leakage flow along the shaft 12 and across the annular teeth 24 was determined by experimental CFD analysis. This leakage determination is plotted in FIG. 2 with porosity being equal to one (1) and resulting relative leakage being equal to about 0.2. Experimental effective damping by the seal configuration 48 was also determined by the experimental CFD analysis. This effective damping determination is plotted in FIG. 2 with porosity being equal to one (1) and effective damping being equal to about 0.05. As expected, as shown in FIG. 2, when compared to the seal configuration 38 of FIG. 2A, the seal configuration 48 of FIG. 2B reduced axial fluid leakage flow (which is desired) and also reduced effective damping (which is not desired).

A series of exemplary experimental CFD analyses were conducted with the seal configuration 50 of FIG. 2C, which as noted above is substantially similar to the seal apparatus 16 as described with reference to FIG. 1 above. During this series of exemplary experimental CFD analyses, the porosity of the porous segments 30 was varied between zero (0) and one (1) to determine the effect of porosity on leakage and damping. The results of the series of exemplary experimental CFD analyses indicated that, if the porosity of the porous segments 30 is greater than or equal to about 0.7 but less than or equal to about 0.95, the effective damping provided by the seal configuration 50 of FIG. 2C is greater than that provided by the seal configuration 48 of FIG. 2B, and the relative axial fluid leakage flow associated with the seal configuration 50 of FIG. 2C is less than that associated with the seal configuration 48 of FIG. 2B. These were unexpected results. For instance, it was unexpected that there would be a range of porosity by which effective damping could be increased and simultaneously axial leakage fluid flow could be reduced, when compared to the seal configuration 48 of FIG. 2B. Although an increase in damping was expected, the combination of increasing damping while further reducing axial fluid leakage flow was unexpected. This range of porosity from about 0.7 to about 0.95 is referred to by the reference numeral 52 in FIG. 2. Within the range of porosity 52, an optimum porosity value 54 was thereby determined. The optimum porosity value 54 is between about 0.75 and about 0.8, and corresponds to maximum damping and minimum leakage.

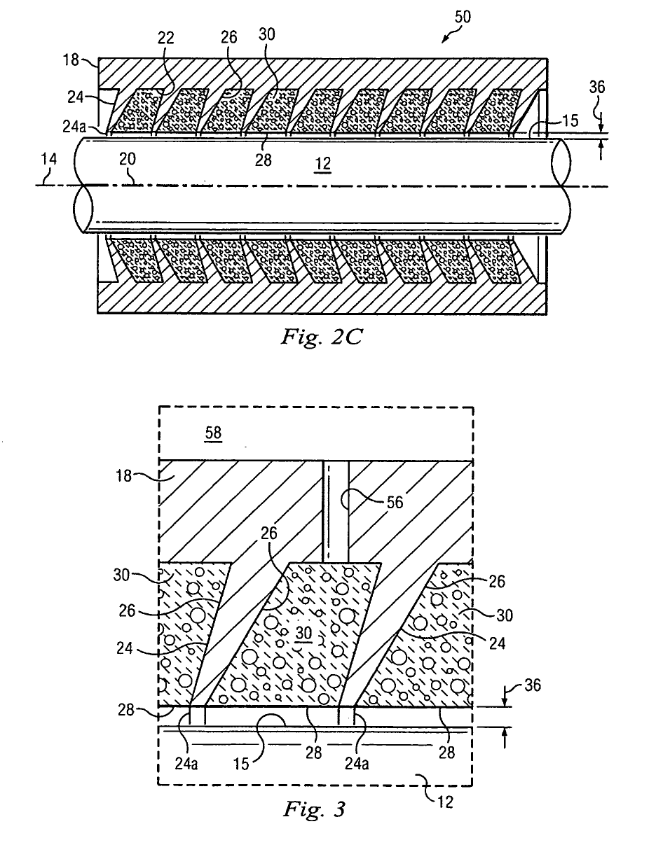

Referring now to FIG. 3, with continuing reference to FIG. 1, the seal apparatus 16 may be modified by adding a shunt hole 56 through the annular member 18. The shunt hole 56 may provide for fluid communication between a high pressure fluidic region 58 of the rotor system 10, such as a diffuser, and one or more of the porous segments 30. In at least one embodiment, the shunt hole(s) 56 may be configured to increase the damping of the shaft 12 vibration during the operation of the rotor system 10.

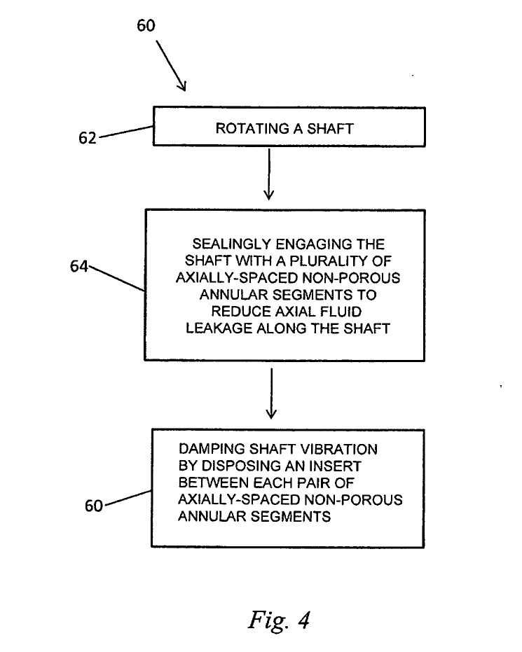

Referring now to FIG. 4, with continuing reference to FIGS. 1-3, a method of sealingly engaging a shaft having a longitudinal axis is generally referred to by the reference numeral 60. The exemplary method may include rotating the shaft, as at 62, and sealingly engaging the shaft with a plurality of axially-spaced, annular segments to reduce axial fluid leakage flow, along the shaft, as at 64. In one or more embodiments, the annular segments may be made of a substantially non-porous substance, such as a solid material. The method may also include damping shaft vibration by disposing or otherwise arranging porous segments or material between each pair of adjacent, axially-spaced annular segments, as at 66.

Although the present disclosure has described embodiments relating to specific turbomachinery, it is understood that the apparatuses, systems and methods described herein could be applied to other environments. For example, according to other exemplary embodiments, instead of, or in addition to turbomachines such as, for example, turbines, motors, generators, centrifugal compressors or other types of compressors, the labyrinth seal apparatus 16 may be employed to sealingly engage components in other types of devices and/or systems.

The foregoing has outlined features of several embodiments so that those skilled in the art may better understand the detailed description that follows. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions and alterations herein without departing from the spirit and scope of the present disclosure.

1. A seal apparatus, comprising:
an annular body having a longitudinal axis and defining an inside surface;
a plurality of axially-spaced annular segments extending radially inward from the inside surface of the annular body; and
a plurality of axially-spaced, porous segments positioned between adjacent axially-spaced, annular segments, wherein the porous segments have a porosity that ranges from about 0.7 to about 0.95.

2. The seal apparatus of claim 1, wherein the plurality of axially-spaced annular segments are composed of a non-porous material.

3. (canceled)

4. The seal apparatus of claim 1, wherein the porous segments have a porosity that ranges from about 0.75 to about 0.8.

5. The seal apparatus of claim 1, wherein a distal end of each porous segment is generally flush with distal ends of axially-adjacent annular segments.

6. The seal apparatus of claim 1, further comprising a shunt hole formed through the annular body so that at least one porous segment fluidly communicates with a fluidic region external to the annular body.

7. The seal apparatus of claim 1, wherein the porous material comprises a porous matrix material.

8. The seal apparatus of claim 7, wherein the porous matrix material is composed of a random array of bonded cylindrical fibers providing isotropic fluid flow resistance.

9. The seal apparatus of claim 7, wherein the porous matrix material is composed of one or more of a metallic felt-like material, a non-metallic woven material, and an open cell foam material.

10. A method of restricting axial leakage along a rotating shaft having a longitudinal axis, the method comprising:
sealingly engaging a shaft with a plurality of axially-spaced annular segments configured to reduce axial fluid leakage flow along the shaft; and
damping shaft vibration by positioning a porous segment between adjacent annular segments, such that the porous segment abuts and extends between the adjacent annular segments, wherein the porous segments have a porosity that ranges from about 0.7 to about 0.95.

11. The method of claim 10, wherein each annular segment is composed of a non-porous material.

12. (canceled)

13. The method of claim 10, wherein a porosity of the porous material ranges from about 0.75 to about 0.8.

14. The method of claim 10, wherein each annular segment has a distal end and a clearance defined between each distal end and the shaft, and wherein the porous material is mounted flush with the respective distal ends of adjacent annular segments.

15. The method of claim 10, wherein the porous segment comprises a porous matrix material composed of a random array of bonded cylindrical fibers providing isotropic fluid porosity.

16. The method of claim 15, wherein the porous matrix material is composed of one or more of a metallic felt-like material, a non-metallic woven material, and an open cell foam material.

17. A seal, comprising:
an annular body having a longitudinal axis and defining an inside surface that extends circumferentially about the longitudinal axis;
a plurality of axially-spaced, annular segments extending radially inward from the inside surface of the annular body and circumferentially about the longitudinal axis, each of the annular segments having a distal end, wherein adjacent annular segments define an annular channel therebetween; and
a porous segment disposed in each annular channel and composed of a porous material, the porous material abutting and extending between the adjacent annular segments and being generally flush with the respective distal ends of the adjacent annular segments, and the porous material having a porosity that ranges from about 0.7 to about 0.95.

18. The seal of claim 17, wherein the annular body further defines one or more shunt holes adapted to allow fluid communication between the porous segment and a fluidic region external to the annular body.

19. The seal of claim 17, wherein the porous material is composed of one or more of a metallic felt-like material, a non-metallic woven material, and an open cell foam material.

20. The seal of claim 17, wherein the porous segment is mechanically-fastened the annular body.
